(19) United States
(12) Patent Application Publication
(10) Pub. No.: US 2014/0322678 A1
(43) Pub. Date: Oct. 30, 2014

(54) PRESENTATION OF FOOD INFORMATION ON A PERSONAL AND SELECTIVE DYNAMIC BASIS AND ASSOCIATED SERVICES

(71) Applicant: KITCHOLOGY INC., Germantown, MD (US)

(72) Inventors: Alain Charles Briancon, Poolesville, MD (US); Iris Sharon Sherman, Rockville, MD (US); Barbara Boyce, Newark, DE (US); Steve Goldberg, Delray Beach, FL (US); Alyson Durham, Keenebunk, ME (US); Ian Thomas Durham, Keenebunk, ME (US); Bill Mandeville, Herndon, VA (US)

(73) Assignee: KITCHOLOGY INC., Germantown, MD (US)

(21) Appl. No.: 14/259,837

(22) Filed: Apr. 23, 2014

Related U.S. Application Data
(60) Provisional application No. 61/815,397, filed on Apr. 24, 2013.
(60) Provisional application No. 61/815,398, filed on Apr. 24, 2013.

(51) Int. Cl. G09B 19/00

(52) U.S. Cl. CPC G09B 19/0092
USPC 434/127

(57) ABSTRACT

A food media processing platform (FMPP) and a computer-implemented method, performed by a processor, are described for processing food nutrition information for presentation to a consumer. Original food nutrition information stored in a first database may be examined to determine key attributes of the original food nutrition information. The determined key attributes of the original food nutrition information may be contrasted with consumer provided information stored in a second database. Modified food nutrition information may be generated based on the contrasting. An algorithm is then performed that compares the key attributes of the modified food nutrition information to a predetermined criteria. The modified food nutrition information may then be presented to the consumer along with supplemental information on a condition that the predetermined criteria has been met.

### CROSS REFERENCE TO RELATED APPLICATIONS

This application claims the benefit of U.S. Provisional Applications No. 61/815,397 and 61/815,398, filed Apr. 24, 2013, which are incorporated herein by reference as if fully set forth. This application is also related to U.S. patent application Ser. No. 14/259,755 filed on Apr. 23, 2014 entitled “Enhanced Food Information Management And Presentation On A Selective Dynamic Basis And Associated Services”, which is hereby incorporated by reference in its entirety.

### BACKGROUND

Food labels and recipes have moved from the realm respectively of food packaging and cook books a few decades ago, to the Internet and the various apparatus used to access them (e.g., computers, tablets, smart phones, and specialized devices). Allrecipes.com (http://www.allrecipes.com), Yummly (http://www.yummly.com/), and Fooducate (http://www.fooducate.com) are but a few examples of this migration from paper to electronic access. The benefits are universal access without the need of a plethora of physical paper products nearby, and ready access to expanded and new instances of the subject matters. Formats have emerged to represent the different components of a recipe. They include hRecipe, a simple, open, distributed format, suitable for embedding information about recipes for cooking in (X)HTML, Atom, RSS, and arbitrary XML (http://microformats.org/wiki/hrecipe), and RecipeML (http://www.formatdata.com/recipeml/spec/recipeml-spec.html).

A food item is a consumable food. A food item may be a naturally occurring food (e.g., apple), or a mixture realized using a recipe (e.g., apple pie). A recipe can be realized at home, a store, or a brand (often referred to as a Consumer Packaged Goods Manufacturer, or CPG) manufacturing facility (e.g., NEWCO frozen apple pie).

A ready to make (RTM) food item is a self-contained item that requires a minimum amount of preparation from the consumer, typically warming in a microwave oven. The recipe associated with such an item can be as simple as “remove tray from carton. Put in microwave oven for 3 minutes”.

A home cooked meal (HCM) food item is an item that requires more effort than an RTM.

Raw food eaten directly (e.g., fresh tomatoes) are often considered to be a HCM, even if not cooked, because of the perceived healthier aspect that HCMs have over RTMs.

Leftovers, like say boiled potatoes, can be simply reheated, making them RTM. Other leftovers, like animal fat, can be reused to compose other meals make them HCMs.

Food activities are numerous, grounded in routines and repetitious/cycling in nature. We refer to the ensemble (set) of food activities as a food cycle. We refer to a food event (or food moment) as events in the food cycle. These include, but not limited to, checking inventory, making a shopping list, delegating the shopping, selecting a store, driving to store, login an online store, navigating through the store, shopping for items, redeeming coupons, paying, delivering the food, having the food delivered, planning meals, searching a recipe, modifying a recipe, preparing to cook, cooking, recording cooking issues, setting the table, eating, sharing the experience with others (in person or through, increasingly, social networks).

An ingredient is a substance part of a mixture. The mixtures are food items (aka dishes) realized using recipes. A recipe is the process used to create a mixture. Ingredients, along with recipe (cooking) steps are the cores of recipes, whether the recipe is used to realize a food item at home, store, or brand manufacturing plant. Ingredients are organized, based on type, origin, species, variety and sub-varieties depending on the level of enthusiasm. Consider the simple case of pepper: http://pepper-passion.com/peppercorn-varieties. Ingredients can be introduced by the recipe making (e.g., oil if deep-frying is the cooking method). Ingredients are also listed as quantitative ingredient food labels are essential as consumers become more dependent on processed, consumer packaged foods (part of the broader Consumer Packaged Goods) because, unlike the purchase of perishable items such as fruits, vegetables, meat or staples, the composition of such products cannot readily be determined by visual inspection. A consumer buying a packaged food product that contains fruit cannot, without a label, determine how much fruit is contained in the package.

Two important food label systems used in the United States are universal product code (UPC) and price look-up (PLU) codes. They are typically attached or printed on the ingredient being purchased.

A UPC may be used by manufacturers to identify products. A UPC generally has two parts: numbers, which people can read, and a series of bars that can be scanned and tracked by computers. The numbers generally indicate both the manufacturer and the specific product (stock-keeping unit (SKU)). The UPC for a 6-pack of strawberry yogurt, a single strawberry yogurt, and single blueberry yogurt from the same manufacturer are different.

PLU codes are four digits identification numbers affixed to produce. They are typically in 3000-4999 range (http://www.plucodes.com/docs/Users_Guide_July_{—}2012_FINAL.pdf), identifying the type of bulk produce, including the variety. The PLU Code for two bananas and one banana are the same. This means that serving information is not readily available based on PLU codes.

Nutritional information includes elements of the U.S. basic food panel information, called the nutrition facts panel. The label begins with a standard serving measurement; calories are listed second, and then followed by a breakdown of the constituent elements. Normally listed are total fat, sodium, carbohydrates and protein; the other nutrients usually shown may be suppressed if they are zero. Usually all 15 nutrients are shown: calories, calories from fat, fat, saturated fat, trans fat, cholesterol, sodium, carbohydrates, dietary fiber, sugars, protein, vitamin A, vitamin C, calcium, and iron.) If a food has an insignificant amount (less than 1 gram or zero) of a nutrient, then it does not need to be listed on the nutrition facts panel. The design of this food panel is heavily regulated and cannot be arbitrarily modified. As of the writing of this specification, however, it is being updated for eventual release as an improved standard.

The nutrition facts panel also lists the serving size and the number of servings per package/container. There is a general lack of understanding of what/how big a serving is, especially in view of restaurant portions and their inconsistency amongst SKUs.

Millions of Americans are on restricted diets. Often this is due to allergies, intolerance, and autoimmune disorders such as celiac disease. Others are on restricted diets to help regulate health conditions such as high blood pressure and diabetes. Adjusting to a new diet for health reasons is often difficult. Favorite foods may suddenly be forbidden and family recipes handed down for generations can no longer be used. Learning how to substitute forbidden ingredients for those that are permitted so that favorite recipes can be enjoyed is an important step in helping a person adhere to his/her diet. The happier a person is on his/her diet the less tempted the person will be to cheat. For many cheating on a diet can be deadly.

Eating can be a very social experience. Often children with allergies, food intolerances or celiac feel ostracized in social settings due to their inability to eat the food served. Having the ability to easily learn appropriate substitutions can help the families of these children to better fit in in social settings where food is served. This same ability can permit family and friends of those on a restricted diet to host their loved one without fear of causing him/her harm or hours spent on researching the ins and outs of the restricted diet. This is especially true at holidays, such as Thanksgiving, where the meal plays an important role in the celebration.

Food allergens are ingredients protein or non-protein, capable of inducing allergy or specific hypersensitivity. Food allergy is an important public health problem that affects children and adults and may be increasing in prevalence. At the very least, it is increasing in consumer awareness. Because patients frequently confuse non-allergic food reactions, such as food intolerance, with food allergies, there is an unfounded belief among the public that food allergy prevalence is higher than it is. Despite the risk of severe allergic reactions, there is no current treatment for food allergy: the disease can only be managed by allergen avoidance or treatment of symptoms.

According to the Food Allergy and Anaphylaxis Network (http://www.foodallergy.org), as many as 15 million people have food allergies in the US. An estimated 9 million, or 4%, of adults have food allergies. An estimated 6 million, or 8%, of children have food allergies with young children affected most. According to the Journal of the American Medical Association, one third of Americans believe they, or their children, have a food allergy. Eight foods account for 90% of all food-allergic reactions: milk, eggs, peanuts, tree nuts (e.g., walnuts, almonds, cashews, pistachios, pecans), wheat, soy, fish, and shellfish. Although childhood allergies to milk, egg, wheat and soy generally resolve in childhood, they appear to be resolving more slowly than in previous decades, with many children still allergic beyond age 5 years. Allergies to peanuts, tree nuts, fish, or shellfish are generally lifelong allergies.

Allergens discussed hereunder are a subset of the ingredients of food items (whether listed in recipes or introduced during the cooking or manufacturing process).

Managing allergens is a difficult task that has not been resolved by existing approaches (often static and standardized) solution. This is true for a multitude of reasons. They include (but not limited to the following):
a. A food item may have different allergens associated with a single consumer (say egg and gluten).
b. The same food item may have different required allergens levels because its intended consumption might not be with the same group of consumers. Consider a family where multiple members each have their own allergy and the handling of meals prepared for all the family or only part of the family.
c. The terminology of food ingredient is not a precise one. A shopper might call something rice noodle and another simply noodles. This makes the creation of definite and static taxonomy of food items that can be readily understood by consumers impossible.
d. The terminology of allergens is also not a precise one. Many consumers equate wheat for gluten; even through gluten can also be found in rye and barley.
e. When thinking of taxonomy of food items, allergen might be inherited from class to subclass. A class of food items might have allergens while a subset of that class does not have allergens. For example, generic flour might have gluten vs. garbanzo bean flour that might not have gluten.
f. The “same” food item from one supplier might have allergens and another does not have.
g. Processing impacts the presence of allergens. For instance, in the processing of soy, the lecithin protein within the food may need to be processed in a different manner in order to prevent the allergy-causing elements to be removed from all food products to ensure the food supply is safe and regulated.
h. While in general one should not provide medical advice unless qualified to do so, a provider of information should be aware however of how consumers look at allergies. There are differences for instance between celiac disease and gluten sensitivity, allergies and food sensitivities.

Helping the consumers deal with nutrition and allergy as general welfare is a key function of governments around the world. These efforts focus on single food items, typically at the procurement oriented stages of the food cycle where the consumer makes purchase decisions.

In the United States, to comply with Food Allergen Labeling and Consumer Protection Act (FALCPA, Food Allergen Labeling and Consumer Protection Act of 2004, 21 U.S.C. 301), the major eight allergens must be declared in simple terms, either in the ingredient list or via a separate allergen statement. See http://www.fda.gov/Food/LabelingNutrition/FoodAllergensLabeling for details. However, FALCPA does not regulate the use of advisory/precautionary labeling (e.g., “may contain”, “in a facility that also processes”) is voluntary. The terms do not reflect specific risks and random products tested for allergens have shown a range of results from none to amounts that can cause reactions.

Although there have been significant advances in scientific tools and data resources since the report's 2006 publication, the Food and Drug Administration (the FDA is the agency that administers the FALCPA) current intent is to determine if the currently available data and analysis tools are sufficient to support a quantitative risk assessment and, if so, to use these data and tools to evaluate the public health impact of establishing specific regulatory thresholds for one or more of the major food allergens.

The European Union has for examples 14 allergens on its lists to even include celery, lupines and sulfites. Industry is being pressured to move away from the wording of “may contain” labeling, as it cannot be used for definite decision making by consumers. Moving to a binary (contains/does not contain) is however difficult to manage. This is true because measurement accuracy will not let a manufacturer or third party tester detect certain items beyond a ppm or ppb level. Thus, an extremely small amount might find itself in the food item (a major issue for cross contamination).

The group VITAL (Voluntary Incidental Trace Allergen Labeling) system developed by the Allergen Bureau of Australia and New Zealand and is now referenced by numerous other countries as well, includes a “traffic light” labeling system. If the allergen level falls in the green zone, no precautionary statement is needed, yellow indicates that a “may be present” (may contain) statement is needed; red denotes that allergen labeling is required.

However well-intentioned these approaches are, they suffer from a fundamental flaw that different individuals and different families have different needs for nutrition and allergens information and any solution that does not take these individuals and families information into account is less than optimal. Any printed (i.e static) solution is fundamentally flawed from the perspective of being tailored to the needs and circumstances of consumers.

The advent of smartphones with their scanning capabilities (using the camera) and high-speed access to the Internet, and thus databases, have brought up new ways to display nutrition information. This is one of the primary ways through which food media has been digitized.

The digitization of food media content (recipes, cook books, grocery circulars) and the ready availability of nutrition data from the USDA Nutrient Database for standard reference (http://www.ars.usda.gov) and others allows the computation of key nutritional attributes in a ready manner.

Packages (typical form factor of Ready to Make—RTMs) have a UPC code to allow for scanning. Different stock-keeping unit (SKUs) have different UPC codes. In a typical application, the consumer scans the UPC code and specific information about nutrition is displayed with more fields. The designs of this digitized food media is set by the applications.

Digital recipe solutions follow the same broad principles as scanning centric applications. The recipe is parsed using natural language processing, items identified, their nutritional attributes extracted, then added across all instances of the recipes.

To be made relevant, the food information being presented should be made context-aware. U.S. Patent Application Publication No. 2013/0175337 by Briancon et al. teaches making scanned information context dependent.

Legacy solutions do not take into account the unique characteristics of the consumers, their likes and dislikes, the context of the interaction, the history of interactions by the consumers and other users associated with the consumers, (e.g., family members and/or friends).

Current digital food media legacy systems are closed systems in that a single entity controls the content and the manner in which information is being displayed. Advertising (directed or through an advertising network) is at times inserted as banners throughout the displayed information.

To be more effective, third parties should be involved in the production of the information to be presented to the consumer, making the food information a platform for education and commerce. These third parties could be other consumers (crowd sourcing), support organizations such as associations helping people coping with food allergies or public interest groups, as well as commercial entities such as retailers and brand manufacturers.

Providers of recipes usually need a way to monetize their involvement. Yummly for instance established an advertising platform allowing for user search parameters and preferences to trigger the display of advertisements that are likely beneficial to the user (http://finance.yahoo.com/news/yummly-announces-revolutionary-advertising-platform-130500950.html). It allows for the search of recipes based on expressed preferences, and the identification of brands that could be used to make up the components of the recipes selected. While this approach provides benefits to suppliers and consumers alike, it has limitations with respect to context-awareness, linkage to specific SKUs, linkage to event in the food cycle, purchasing options, and compliance with goals. All of which will be addressed by the present invention.

U.S. Pat. No. 7,228,493 by Kosak et al. teaches the examination of the content of a web page, and based upon it inserting additional components into the page such as syndicated content including news feeds, weather information, stock information, road maps, pictures, video, audio and/or text. This insertion is done in a manner that is substantially in the style of the source file. This allows the blending of commercial content with the original web page. It does not seek to replace the look and feel of the web page, an approach that can benefit the consumer greatly. It has limitations with respect to context-awareness, linkage to specific SKUs, linkage to position in the food cycle, purchasing options, and compliance with user goals. All of which will be addressed by the present invention.

U.S. Patent Application Publication No. 2014/0089321 by Engel et al. teaches recommending recipes based on consumer criteria (like and dislike) and processing of specific nutritional variable. It is similar to U.S. Pat. No. 8,364,545 by Arsenault, which teaches dealing with food and wine pairing in that both use nutrition scores to present information and make recommendations. These two documents do not take consumer specific context into account, change the look and feel of the communication, and provide purchasing options.

### SUMMARY

A food media processing platform (FMPP) and a computer-implemented method, performed by a processor, are described for processing food nutrition information for presentation to a consumer. Original food nutrition information stored in a first database may be examined to determine key attributes of the original food nutrition information. The determined key attributes of the original food nutrition information may be contrasted with consumer provided information stored in a second database. Modified food nutrition information may be generated based on the contrasting. An algorithm is then performed that compares the key attributes of the modified food nutrition information to a predetermined criteria. The modified food nutrition information may then be presented to the consumer along with supplemental information on a condition that the predetermined criteria has been met.

Recipes are examined to ascertain their key attributes, and based on these key attributes, additional information elements are selected that will be of benefit to the consumer based on his or her circumstances. The additional information elements may be specific instances of ingredients that the consumer may want to consider using because they are for instance favorably priced in general, a coupon is available for their purchase, or a particular store is offering it at a discount. When considering multiple ingredients, the information could be such that a significant subset of the ingredients is available from a particular distribution source. A key attribute of the presented methods is that they deal with the modification of existing recipes based on a calculated like or dislike individuals have for the resultant recipe. A key circumstance is the consumer activity event in the food cycle.

The FMPP may be implemented in many ways. The hardware, for instance but not restricted to, may be a personal device specifically designed for individuals to utilize for a given purpose, or a general use device where the FMPP function is selectively operated by means of a special program being on the hardware platform, (personal computer running Windows or MacOS operating systems, portable phone running Android or iOS operating system), or a general access program such as an Internet browser connecting to a web site hosted on a remote computer. In general, they all use at least one computer processing device, memory for immediate processing of information, and memory for long term storage of information.

The FMPP in order to provide the complex and diverse information and processing necessary to the implementation of the present invention, will usually have means to communicate with other computer processing and information storage platforms. Some of these may be other FMPP instances, while many will be ignorant of the existence of FMPPs. FMPPs have integrated or remotely accessible human interfaces for both the user of the platform's capabilities, and for various personnel necessary to its maintenance.

Described herein are methods and apparatus for the displaying of nutritional information for ingredients, prepared foods, prepared meals that ascertain consumer and item key attributes, consumer circumstances and based on these key attributes select information elements that will be of benefit to the consumer. A key attribute of the presented methods is that they deal with the presentation of nutrition metrics based on a like or dislike individuals have for specific items. A key circumstance is the consumer activity position in the food cycle. The apparatus supporting these methods is an advanced FMPP.

### BRIEF DESCRIPTION OF THE DRAWINGS

The following detailed description of the preferred embodiments of the present invention will be better understood when read in conjunction with the appended drawings. For the purpose of illustrating the invention, they are shown in the drawings embodiments, which are presently preferred. It is understood, however, that the invention is not limited to the precise arrangements and instrumentalities shown. In the drawings:

FIG. 1 shows a food cycle with constituent parts for procurement and consumption, and implication for the display of food related information by a food media processing platform (FMPP);

FIG. 2 is an example of price look-up (PLU) codes interpreted by embodiment of the invention;

FIGS. 3A-3C are examples of U.S. basic food panel information, (i.e. a nutrition facts panel), contrasted with the context rich labels enabled by the invention;

FIGS. 4A-4C show the different users and components of a platform supporting nutrition management and presentation services per the precepts of the invention (lines labeled A, B, C, D, and E in FIG. 4A are continued by lines in FIG. 4C correspondingly labeled A, B, C, D, and E, and lines labeled F, G, H, I, and J in FIG. 4A are continued by lines in FIG. 4B correspondingly labeled F, G, H, I, and J, such that the FIGS. 4A-4C form one drawing; and

FIG. 5 is a flow diagram of a procedure for processing food nutrition information for presentation to a consumer.

### DETAILED DESCRIPTION OF EXEMPLARY EMBODIMENTS

Certain terminology is used in the following description for convenience only and is not limiting.

As used herein, “connected” means that elements within the system are connected physically or through a remote connection such that they are functionally connected. This connection can be temporary or permanent. As a non-limiting example, a remote connection may be through a localized Radio Frequency link. The connection may also be remotely established over connections supporting protocols such as the many commonly used over the Internet.

The words “grocery store”, “supermarket”, “store”, “commerce”, “commerce-site”, “ecommerce” are used interchangeably unless stated otherwise.

Stores can be brick and mortar stores or virtual/digital on the Web/Internet.

Coupons can be physical (paper, circular) or electronic (on PC, phone).

As used herein, “scanning” means extracting information from an object from another device. Non-limited examples include using an optical camera, Infrared, RF, RFID, microphone.

The words “coupon” and “e-coupon” are used interchangeably.

The words “extractor”, “extraction device” and “extracting device” are used interchangeably.

All numbers expressing quantities of ingredients, goods, properties, and other parameters used in the specification and claims may be modified in all instances by the term “about.” Unless indicated to the contrary, the numerical parameters set forth in the following specification and attached claims are approximations that may vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The words “a” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

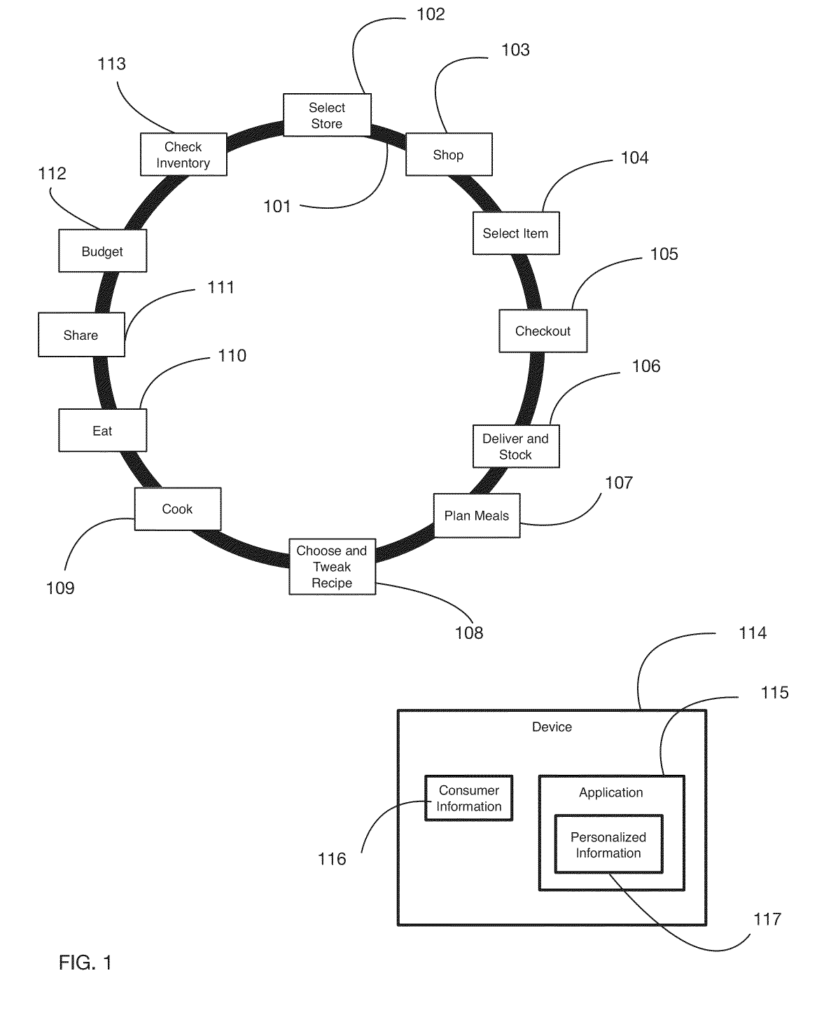

FIG. 1 illustrates a conceptual food cycle (101) used by the consumer and a food media processing platform (FMPP). It includes, but not limited to and doesn't assume a specific sequencing, selecting a store (102) which may be online, shopping (103) that is the examination of one or more items or services (e.g., delivery option), selecting an item (104), an essential moment for marketing, checking out (105), delivery and stocking (106), which involves physical interaction with food, plan meals (107), choose and tweaking recipe (108), cooking (109), eat (110), alone or with others, sharing the experience (111), budget (112), and checking inventory (113) are exemplary instances of the steps during which this invention may be employed.

FIG. 1 shows the general form of a device (114) the consumer utilizes in their exchange of information with the FMPP enabled by this invention. Typical devices, but not limited to, are cellular telephones, personal digital assistants, general use computers in all their instances (e.g., desktops, laptops, netbooks, work stations, electronic pads, wearable), and specialized computers such as those made to enhance the shopping experience. The specialized versions are usually simpler to use since they are targeted to a specific use, and therefore not burdened by extraneously hardware or software needed for other purposes. The device is running an application (115). Based on the consumer information (116) and the estimation of the location within the food cycle, the same conditions will trigger different information to be presented to the consumer (117). This information can be presented in whole or in part using text, audio, video, image, sound, vibration or a combination thereof.

In an embodiment, the information presented to the consumer for a recipe, a food item or any other food related item or processing step is different at different events on the food cycle. The position in the food cycle can be explicitly set by the user or implied from processing one or more external stimuli.

An FMPP may be implemented in many ways. The hardware for instance may be a personal device specifically designed for individuals to utilize for a given purpose, or a general use device where the FMPP function is selectively operated by means of a special program being on the hardware platform (e.g., IBM personal computer architecture or MacIntosh), or a general access program such as an Internet browser connecting to a website hosted on a remote computer. In common they all use at least one computer processing device, memory for immediate processing of information, and memory for long term storage of information.

The FMPP in order to provide the complex and diverse information and processing necessary to the implementation of the present invention, will usually have means to communicate with other computer processing and information storage platforms. Some of these may be other FMPP instances, while many will be ignorant of the existence of FMPPs.

FMPPs have integrated or remotely accessible human interfaces for both the user of the platform's capabilities, and for various personnel necessary to its maintenance. The food cycle event can be explicitly set by the user or implied from processing one or more external stimuli.

In one embodiment, machine learning is used to estimate at which event in the food cycle a function is performed. Having this estimation is important for instance where scanning is used as part of the process. For instance, scanning can be used at a store (food cycle locations 103, 104, 105), and scanning can be used at home (food cycle locations 106, 107, 112, 113). Knowing through say geo-location or connection to a local wireless access point if the consumer is at home or away, allows the ready determination of which cluster of food cycle events this interaction is most likely to be in. Rapid sequential scanning of food of the same type, say soups, is likely the selection of soups to purchase (103) rather than finding a recipe that leverages said soup (107, 108). In the former case, nutrition information (or a coupon offer) is more appropriate to be presented. In the latter, recipe information is more appropriate. The consumer of course always has the option to override the conclusion presented by the machine learning component of the FMPP. Such an override may also be taken into account the next time a similar situation is ascertained. In fact, all choices can be taken into account a similar situation is determine to be in effect for a particular consumer, or temporally taken into account if the consumer appears to be performing an exception to normal activities (say as because a guest is coming for dinner). Another example is the case when shopping is occurring, but the consumer wanted to examine a recipe to determine some information.

In another embodiment, the consumer information is static. In another embodiment, the consumer information is dynamic.

In an embodiment, a mobile application running on a smart phone is used to present information on a selective basis based on its estimate of the position on the food cycle.

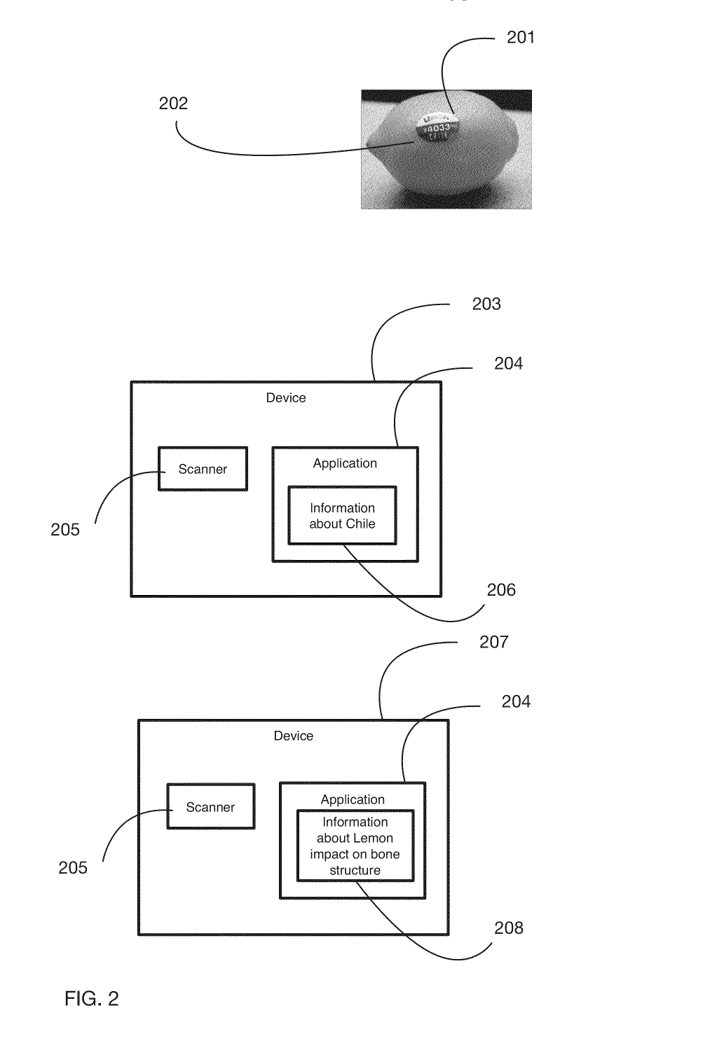

While involved in each of the steps of procurement and consumption of food, the user is presented with many forms of information when interfacing with the Food Media Processing Platform. FIG. 2 shows an embodiment of the invention dealing with rich contextual information triggered by a price look-up (PLU) code. The PLU code may not be directly useful to the consumer, but when inputted to a computing resource implementing this invention, provides the means to access various databases and obtain from them information about the tagged food. A lemon (201) has a PLU label (202) affixed to it. Two devices (203) and (207) running an embedded application (204) may extract the PLU information through scanning (205) using optical character recognition or directly entered by the user (components not shown) by a keypad or verbalization. The device (203) may be programmed to display country of origin information when scanning a PLU and presents said country of origin (206) to a consumer (206). The device (207) may be programmed to display health information when scanning a PLU code and present information about the impact of a lemon on bone structure (208) to the consumer.

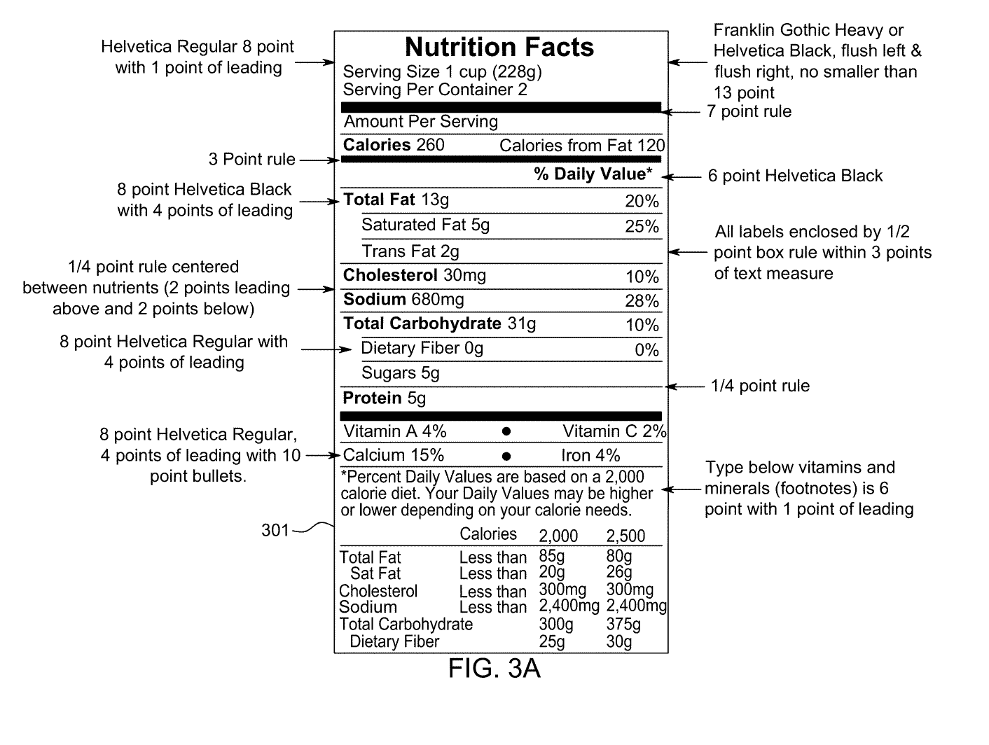

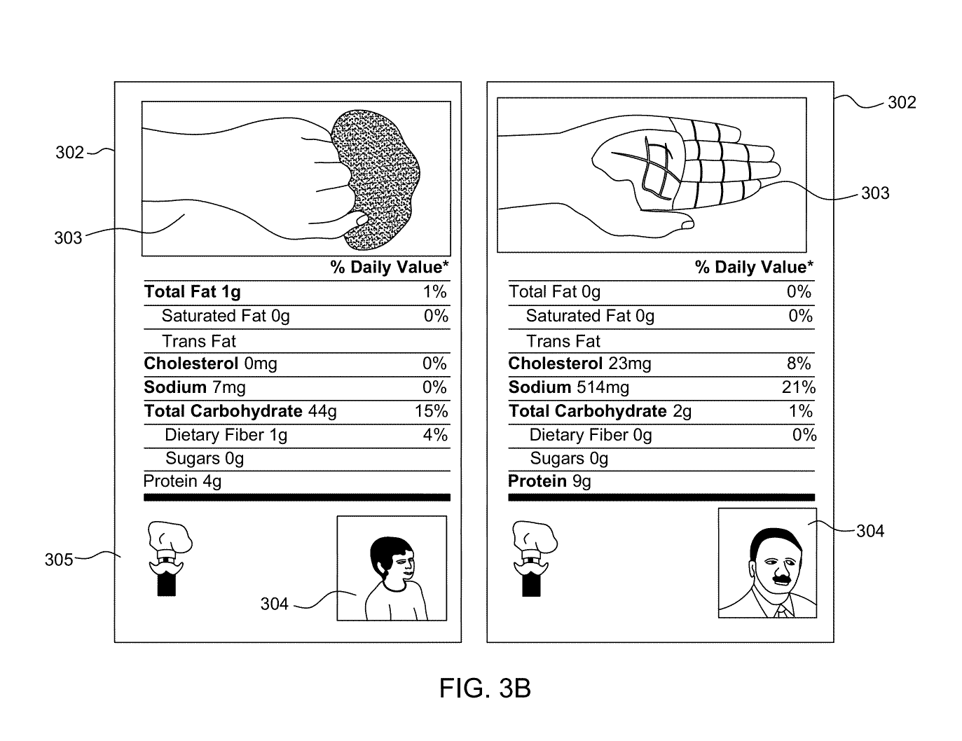

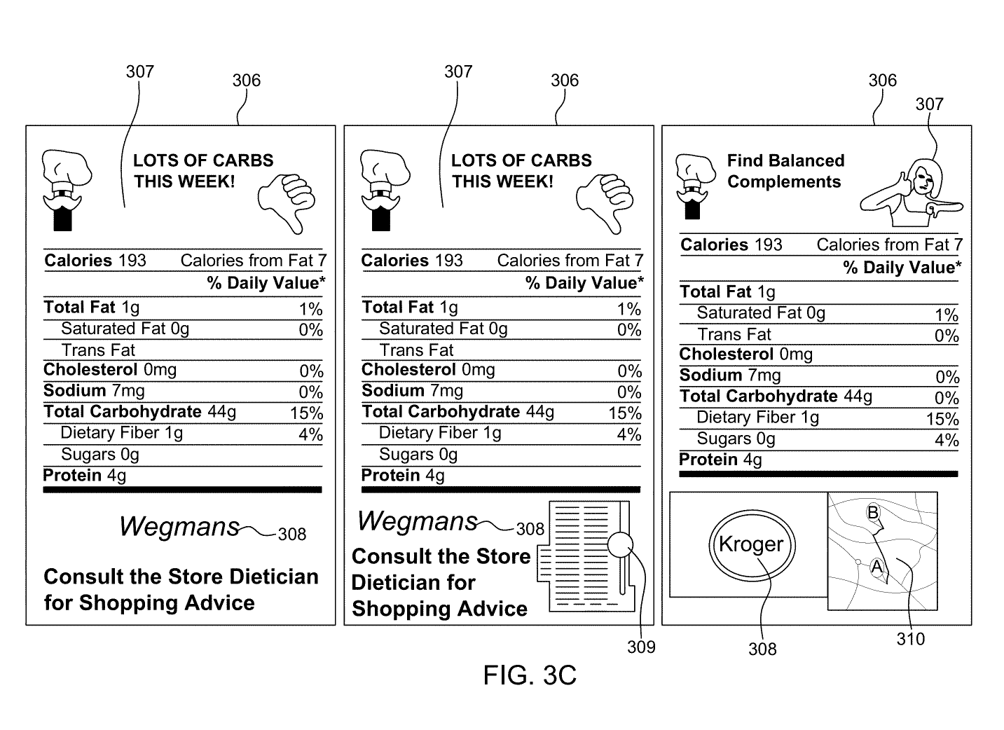

FIGS. 3A-3C illustrate the current food panel (301) and personalized food panels enabled by this invention. Panels (302) may be rendered on a smartphone and render graphic, images, videos and/other multimedia content (303) illustrating the serving size associated with the food being scanned. These panels may be fetched from a server based on the SKU being scanned. Reinforcing personalization, such as a picture of a loved one (304), may be attached to the panel (302) (evidently different for each consumer). Lastly, a distinctive branding icon such as a logo (305) may be integrated for marketing purposes. This invention supports even more advanced and personalized food labels (306). The consumption history of the consumer may be used to generate suggestive or reinforcing messages (307). The location of the smart phone may be used to enhance the personalized food labels (306). Whenever the smartphone is within the geo-fencing perimeter of a store, the name of the store may be displayed (308). If the scanning takes place within the store, a specific location (309) may be displayed. If the scanning takes place outside of the store, a map to the store may be displayed (310).

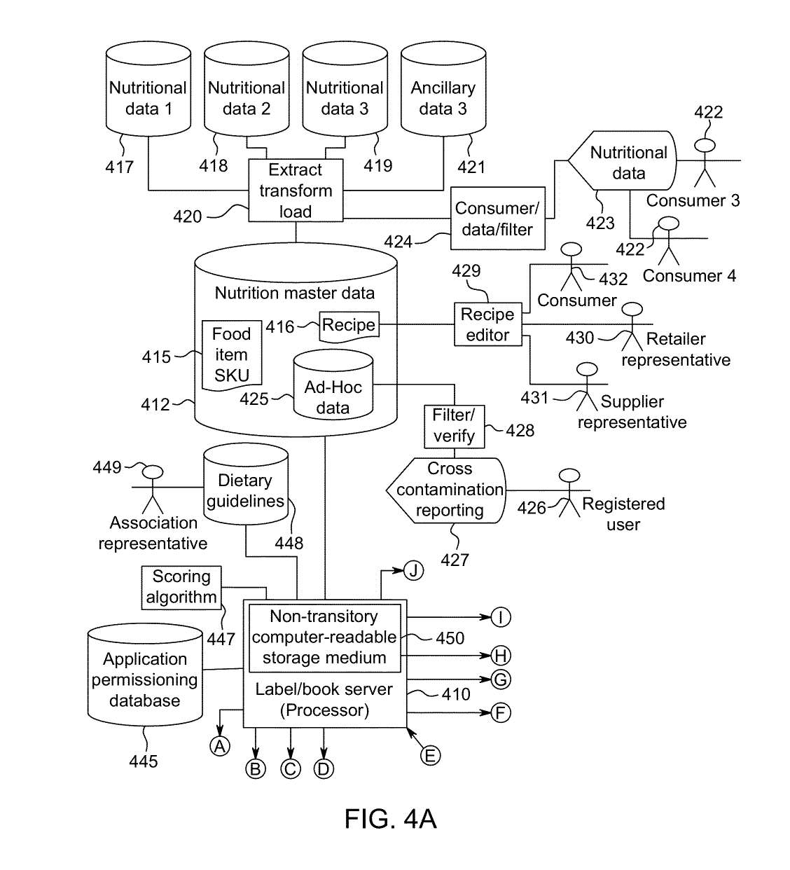

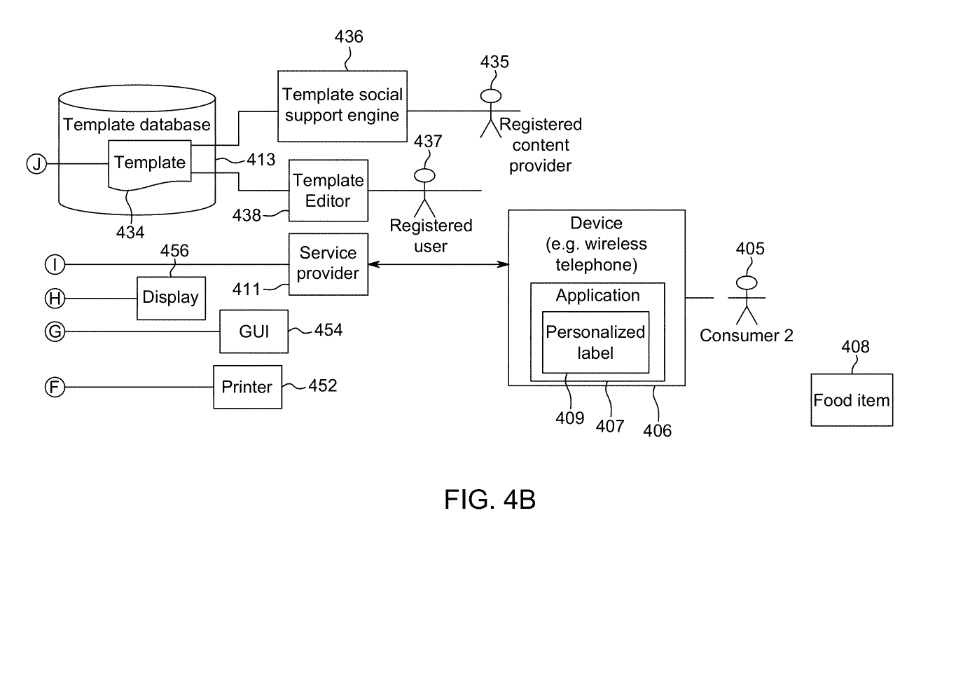

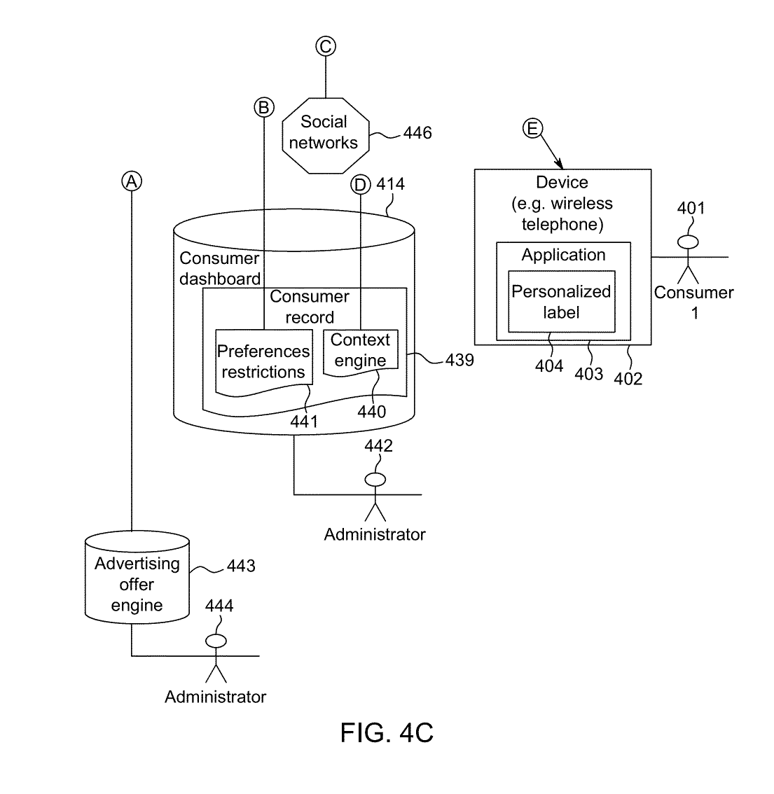

FIGS. 4A-4C show the information rich processing opportunities enabled by this invention. In this embodiment, a consumer (401) may use a computing device (402) such as, but not limited to, a computer, a wireless telephone, a smart phone or a tablet to run an application (403). This application (403) may display at least one food label (404) that may be tailored to the consumer needs, circumstances and interest. Another consumer (405) may use another computing device (406) running an application (407), which may be the same as application (403). The application (406) may scan information associated with a food item (408) and display a personalized food label (409) associated with the consumer's needs, circumstances and the food item (408). The devices (402) and (406) may communicate with a label/book server (410) directly, or in the case of device (406), through a service provider network (411). It should be noted that portable devices such as a smartphone may capture their location information as a course of normal operation. Location and time information may be used to establish or manage some of the consumer's needs.

The label/book server (410) may communicate with three principal components, namely a nutrition master database (412), a template database (413) and a consumer dashboard database (414).

The nutrition master database (412) may allow retrieval of information based on a food item SKU (415) or a recipe (416) among others. It can be implemented using postgress, MySQL, MondoDB or any appropriate database management schema. The nutrition master database (412) may include information from multiple nutritional databases (417), (418) and (419). There are various ways to exchange information with the databases. For example, information from database 417 may be accessed through an application-programming interface (API), information from database 418 may be accessed through a RESTful API, and information from database 419 may be accessed via file transfer. The exchange may be purely a retrieval operation, or it may be a submission of information which induces some processing by the database followed by it providing determined information. To ensure the quality of the data, an extract, transform and load (ETL) processor (420) may be selectively applied to the data. The first part of an ETL process may involve extracting the data from the databases. The transform stage applies a series of rules or functions to the extracted nutritional data from the original database to derive the data for loading into the end master database. The loading of the data is typically done on a scheduled basis based on the amount of new recipes or new items available in stores or dynamically synchronized with key events or processes. An ancillary database (421) may also be integrated, and may contain elements not typically captured by a nutritional database, such as pictures and other multimedia content of ingredients, food items, videos, country of origin or production location. Traditional nutritional databases may be corporate or governmental in nature, having been gathered from scanning information from packaging, regulatory filing, academic research and/or other publicly accessible information either freely available or under subscription.

Consumers (422) may provide additional nutritional information (423), such as the presence of an allergen not mandated for government regulation, or the compliance of a food item with a religious code. To prevent corruption of the data, a filtering function (424) may be implemented before the data is passed to the ETL processor (420).

Another source of information is ad-hoc information (425). This information may be entered by a registered user (426). This registered user (426) may enter cross-contamination information (427) and the like, which may be filtered (428) and stored in the ad-hoc data portion of the master database for use. Such information may be subject to review for correctness, as it may not be correct, correctly entered by the user, or obtained from a malicious source. Until such a review occurs, it may be flagged in the database and any viewing or use by the user, pending the review. The actual review may be by artificial intelligence (AI) processing and/or humans. The results may be reported to the user, either automatically (e.g., via email), or when utilization is associated with its instance. The review may allow unimpeded use of the information, block the information, request further clarification, allow forced usage when appropriate (i.e., trusted and authenticated authority provided the input), or be flagged with a statement as to its limitations.

Recipes (416) may be entered through a recipe editor (429) by either a retailer representative (430), a supplier representative (431) or a consumer (432).

The template database (413) may include one more templates (434). They can be static in nature, or interactive, include text, images, videos, audio files, software, or logic (among others). The templates (434) may be created by a registered content provider (435) using a template social support engine (436), or by registered users (437) using a generic template editor (438).

The consumer dashboard database (414) may contain a set of consumer records (439) that capture information about consumer food preferences (441), such as type, timing of activities, shopping preferences, eating preference, and the like, and restrictions (441), such as allergies, diets, and the like. The consumer dashboard database (414) may also include a context engine (440) that encodes heuristics about consumer behavior and goal. The consumer dashboard database (414) may be administrated by an administrator (442).

The label/book server (410) may also be connected to an advertising or offer engine (443) administrated by an administrator (444), an application/permissioning database (445) that controls which applications display which labels under what circumstances. Integration to socials networks (446) directly onto the label, or logic generating the labels, is possible. The label/book server (410) may be connected to a scoring algorithm system (447) that computes relevant attributes based on information collected from the multiple databases of the system. A dietary guideline database (448) may also be integrated into the system and administrated by an association representative (449).

By determining the event position of the consumer activity in the food cycle the user, using the knowledge from basic sources such as the PLU codes and labels, and extended information from the sources shown in FIGS. 4A-4C may be used to tailor information presented to the user. The FMPP may extrapolate additional information that may assist the user in making decisions, taking the user's personal goals into account. This processing may be distributed physically at various physical entities, such as computer servers in a network cloud, personal computers, or portable appliances such as smart phones. Such goals may include nutritional requirements, monetary considerations, likes and dislikes, shopping convenience, and just about any other consideration the user may want to influence each stage of the food cycle.

A scoring algorithm may be used to create unusual and interesting experiences for consumers. For some consumers, dietary guidance should be lifted under certain circumstances. In one embodiment, the scoring algorithm may alter the computation of calories under certain circumstances, such as an accumulated history of food consumption, or removing the calories associated with chocolate. Thus, during the end of the year, a consumer may feel less guilty about indulging in eating truffles and chocolate cake.

An integral component of the issuance of a personal label may be an invitation or trigger, (i.e., an information trigger), to engage in a transaction or other activity related to that interaction with the label. Any type of transaction or activity may be proposed or offered, whether commercial or non-commercial in nature. Examples of transactions or other activities that may be proposed or offered include, but are not limited to, matters related to advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, interchange fee per transaction, fulfillment, licensing, data, user data, user evaluations, business data, user intelligence, search data, real consumer intent data, benchmarking services, market research, push services, link to an app store, coupons, digital-to-physical, subscription, online education, crowd sourcing education, delivery, gift recommendation, coupons, loyalty program, alerts, and coaching.

As shown in FIGS. 4A-4C, the label/book server (410) may be a processor including a non-transitory computer-readable storage medium (450). The processor may perform a computer-implemented method for processing food nutrition information for presentation to a consumer. The label/book server (410) may be connected to a printer (452), a graphical user interface (GUI) (454) and a display (456).

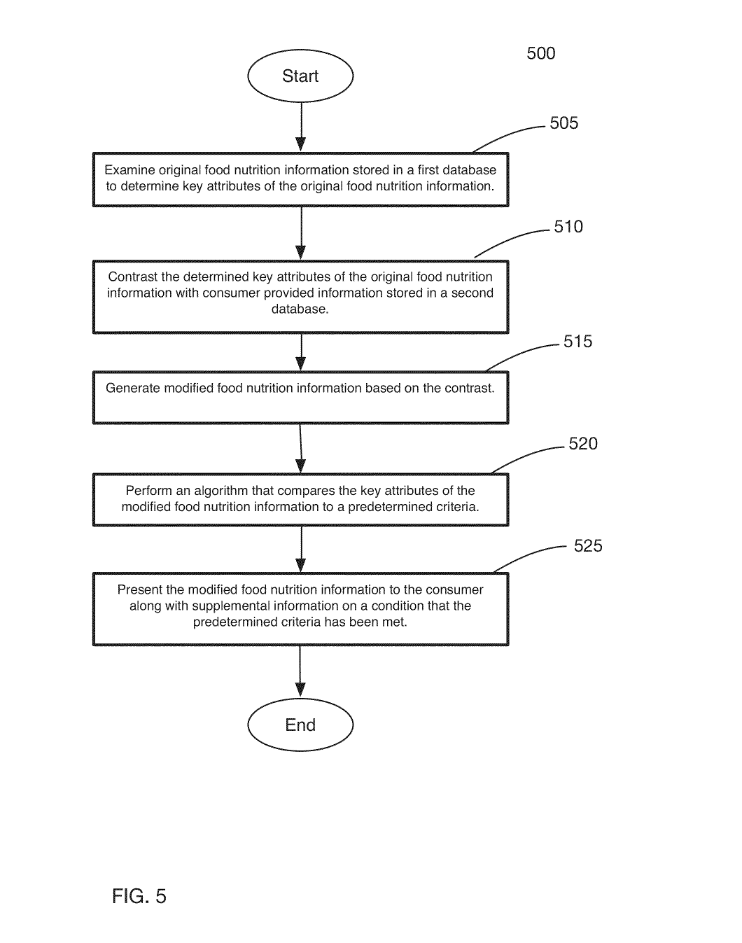

FIG. 5 is a flow diagram of a procedure 500 performed by a processor, such as the label/book server (410) shown in FIGS. 4A-4C. In the procedure 500 shown in FIG. 5, a computer-implemented method is performed by a processor for processing food nutrition information for presentation to a consumer. The processor may examine original food nutrition information stored in a first database to determine key attributes of the original food nutrition information (505). The processor may contrast the determined key attributes of the original food nutrition information with consumer provided information stored in a second database (510). The processor may generate modified food nutrition information based on the contrast (515). The processor may perform an algorithm that compares the key attributes of the modified food nutrition information to a predetermined criteria (520). The processor may present the modified food nutrition information to the consumer along with supplemental information on a condition that the predetermined criteria has been met (525).

The key attributes may be determined based on at least one of: text and images of the presented supplemental information and modified food nutrition information, historical information related to the consumer, historical information related to navigation that brought the consumer to the presented supplemental information and modified food nutrition information, or information available from references the presented supplemental information and modified food nutrition information makes to other sources.

The criteria may indicate at least one of: a nutrition information attribute, presence of specific ingredients, absence of specific ingredients, geographic location of a food item, geographic location of presentation, origin of a food item, genetically modified organism (GMO) status, cost information, pricing information, or compliance to specific diet.

The compliance to specific diet may indicate at least one of: a programmatic modification of calorie count, sugar content, salt content, alcohol content, an ingredient, or nutritional value of ingredients.

The key attributes indicate at least one of: time of day, day of week, location, co-location with at least one designated consumer, position in the food cycle, activities from selected consumers, history information about consumer, or a diet program.

The criteria may indicate at least one of: consumer specific nutrition restrictions, a rating against a nutritional metric, food items on hand, food items in selected inventory locations, a food list to be bought prior to need, a like/dislike value, a presentation procedure, or presentation characteristics.

The supplemental information presented may be at least one of: selection of stores where at least one necessary ingredient of a recipe under consideration can be obtained, brands or stock-keeping units (SKUs) suitable for at least one necessary item usage of a recipe, or a consumer buying incentive.

The consumer provided information may include lists indicating which stores the consumer is willing to visit and not willing to visit. The lists may be enabled or disabled for selected items or in their entirety at the discretion of the consumer.

The modified food nutrition information may include at least one brand name associated with a source of nutritional products.

The supplemental information may be a trigger for at least one of: advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, fulfillment, licensing, data, user data, user evaluations, business data, user intelligence, search data, real consumer intent data, benchmarking services, market research, push services, link to an app store, coupons, subscription, online education, crowd sourcing education, delivery, gift recommendation, coupons, loyalty program, alerts, coaching, advertising message budgeting information, audio media rendering, or video media rendering

Referring again to FIGS. 4A-4C, the non-transitory computer-readable storage medium (450) may contain a set of instructions for processing food nutrition information for presentation to a consumer. The set of instructions may include: 1) a first instruction for examining original food nutrition information stored in a first database of the system to determine key attributes of the original food nutrition information; 2) a second instruction for contrasting the determined key attributes of the original food nutrition information with consumer provided information stored in a second database; 3) a third instruction for generating modified food nutrition information based on the contrasting; 4) a fourth instruction for performing an algorithm that compares the key attributes of the modified food nutrition information to a predetermined criteria; and 5) a fifth instruction for presenting the modified food nutrition information to the consumer along with supplemental information on a condition that the predetermined criteria has been met.

The references cited throughout this application, are incorporated for all purposes apparent herein and in the references themselves as if each reference was fully set forth. For the sake of presentation, specific ones of these references are cited at particular locations herein. A citation of a reference at a particular location indicates a manner in which the teachings of the reference are incorporated. However, a citation of a reference at a particular location does not limit the manner in which all of the teachings of the cited reference are incorporated for all purposes.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A computer-implemented method, performed by a processor, for processing food nutrition information for presentation to a consumer, the method comprising:
the processor examining original food nutrition information stored in a first database to determine key attributes of the original food nutrition information;
the processor contrasting the determined key attributes of the original food nutrition information with consumer provided information stored in a second database;
the processor generating modified food nutrition information based on the contrasting;
the processor performing an algorithm that compares the key attributes of the modified food nutrition information to a predetermined criteria; and
the processor presenting the modified food nutrition information to the consumer along with supplemental information on a condition that the predetermined criteria has been met.

2. The computer-implemented method of claim 1 wherein the key attributes are determined based on at least one of: text and images of the presented supplemental information and modified food nutrition information, historical information related to the consumer, historical information related to navigation that brought the consumer to the presented supplemental information and modified food nutrition information, or information available from references the presented supplemental information and modified food nutrition information makes to other sources.

3. The computer-implemented method of claim 1 wherein the criteria indicates at least one of: a nutrition information attribute, presence of specific ingredients, absence of specific ingredients, geographic location of a food item, geographic location of presentation, origin of a food item, genetically modified organism (GMO) status, cost information, pricing information, or compliance to specific diet.

4. The computer-implemented method of claim 3 wherein the compliance to specific diet indicates at least one of: a programmatic modification of calorie count, sugar content, salt content, alcohol content, an ingredient, or nutritional value of ingredients.

5. The computer-implemented method of claim 1 wherein the key attributes indicate at least one of: time of day, day of week, location, co-location with at least one designated consumer, position in the food cycle, activities from selected consumers, history information about consumer, or a diet program.

6. The computer-implemented method of claim 1 wherein the criteria indicates at least one of: consumer specific nutrition restrictions, a rating against a nutritional metric, food items on hand, food items in selected inventory locations, a food list to be bought prior to need, a like/dislike value, a presentation procedure, or presentation characteristics.

7. The computer-implemented method of claim 1 wherein the supplemental information presented is at least one of: selection of stores where at least one necessary ingredient of a recipe under consideration can be obtained, brands or stock-keeping units (SKUs) suitable for at least one necessary item usage of a recipe, or a consumer buying incentive.

8. The computer-implemented method of claim 7 wherein the consumer provided information includes lists indicating which stores the consumer is willing to visit and not willing to visit.

9. The computer-implemented method of claim 8 wherein the lists can be enabled or disabled for selected items or in their entirety at the discretion of the consumer.

10. The computer-implemented method of claim 1 wherein the modified food nutrition information includes at least one brand name associated with a source of nutritional products.

11. The computer-implemented method of claim 1 where the supplemental information is a trigger for at least one of: advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, fulfillment, licensing, data, user data, user evaluations, business data, user intelligence, search data, real consumer intent data, benchmarking services, market research, push services, link to an app store, coupons, subscription, online education, crowd sourcing education, delivery, gift recommendation, coupons, loyalty program, alerts, coaching, advertising message budgeting information, audio media rendering, or video media rendering.

12. A food media processing platform (FMPP) comprising:
a first database;
a second database; and
a processor configured to examine original food nutrition information stored in the first database to determine key attributes of the original food nutrition information, contrast the determined key attributes of the original food nutrition information with information provided by a consumer and stored in the second database, generate modified food nutrition information based on the contrast, perform an algorithm that compares the key attributes of the modified food nutrition information to a predetermined criteria, and presents the modified food nutrition information to the consumer along with supplemental information on a condition that the predetermined criteria has been met.

13. The FMPP of claim 12 wherein the key attributes are determined based on at least one of: text and images of the presented supplemental information and modified food nutrition information, historical information related to the consumer, historical information related to navigation that brought the consumer to the presented supplemental information and modified food nutrition information, or information available from references the presented supplemental information and modified food nutrition information makes to other sources.

14. The FMPP of claim 12 wherein the criteria indicates at least one of: a nutrition information attribute, presence of specific ingredients, absence of specific ingredients, geographic location of a food item, geographic location of presentation, origin of a food item, genetically modified organism (GMO) status, cost information, pricing information, or compliance to specific diet.

15. The FMPP of claim 14 wherein the compliance to specific diet indicates at least one of: a programmatic modification of calorie count, sugar content, salt content, alcohol content, an ingredient, or nutritional value of ingredients.

16. The FMPP of claim 12 wherein the key attributes indicate at least one of: time of day, day of week, location, co-location with at least one designated consumer, position in the food cycle, activities from selected consumers, history information about consumer, or a diet program.

17. The FMPP of claim 12 wherein the criteria indicates at least one of: consumer specific nutrition restrictions, a rating against a nutritional metric, food items on hand, food items in selected inventory locations, a food list to be bought prior to need, a like/dislike value, a presentation procedure, or presentation characteristics.

18. The FMPP of claim 12 wherein the supplemental information presented is at least one of: selection of stores where at least one necessary ingredient of a recipe under consideration can be obtained, brands or stock-keeping units (SKUs) suitable for at least one necessary item usage of a recipe, or a consumer buying incentive.

19. The FMPP of claim 12 wherein the consumer provided information includes lists indicating which stores the consumer is willing to visit and not willing to visit.

20. The FMPP of claim 19 wherein the lists can be enabled or disabled for selected items or in their entirety at the discretion of the consumer.

21. The FMPP of claim 12 wherein the modified food nutrition information includes at least one brand name associated with a source of nutritional products.

22. The FMPP of claim 12 where the supplemental information is a trigger for at least one of: advertising, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, fulfillment, licensing, data, user data, user evaluations, business data, user intelligence, search data, real consumer intent data, benchmarking services, market research, push services, link to an app store, coupons, subscription, online education, crowd sourcing education, delivery, gift recommendation, coupons, loyalty program, alerts, coaching, advertising message budgeting information, audio media rendering, or video media rendering.

23. A non-transitory computer-readable storage medium containing a set of instructions for processing food nutrition information for presentation to a consumer, the set of instructions comprising:
a first instruction for examining original food nutrition information stored in a first database of the system to determine key attributes of the original food nutrition information;
a second instruction for contrasting the determined key attributes of the original food nutrition information with consumer provided information stored in a second database;
a third instruction for generating modified food nutrition information based on the contrasting;
a fourth instruction for performing an algorithm that compares the key attributes of the modified food nutrition information to a predetermined criteria; and
a fifth instruction for presenting the modified food nutrition information to the consumer along with supplemental information on a condition that the predetermined criteria has been met.
